(19) United States
(12) Patent Application Publication
(10) Pub. No.: US 2008/0250741 A1
(43) Pub. Date: Oct. 16, 2008

(54) Fire resistant fibrous composite articles

(75) Inventors: Proserfina D. Bennett, Bangor, ME (US); Michael A. Bilodeau, Brewer, ME (US); Donna A. Johnson, Orono, ME (US); Mark A. Paradis, Old Town, ME (US); Jonathan M. Spender, Enfield, ME (US); Patrick S. Chiboroski, Sunbury, PA (US); Craig D. Christiansen, Northfield, IL (US); Mark W. Custer, Winfield, PA (US); Marc A. Golden, Miami, FL (US); David A. Hargreaves, Lewisburg, PA (US); Steven S. Healy, Turner, ME (US); Brad W. Johnson, Littleton, CO (US); Thomas S. Verrill, Brunswick, ME (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignees: University of Maine System Board of Trustees; Knight Industries LLC

(21) Appl. No.: 12/080,905

(22) Filed: Apr. 7, 2008

Related U.S. Application Data
(60) Provisional application No. 60/923,236, filed on Apr. 13, 2007.
(60) Provisional application No. 61/067,160, filed on Feb. 26, 2008.

(51) Int. Cl. E04B 1/94; B32B 7/02; C09K 21/02; E04B 7/00

(52) U.S. Cl. 52/506.01; 428/220; 252/601; 252/607; 52/741.3

(57) ABSTRACT

A fire resistant fibrous composite article includes fibers bound together into a consolidated fibrous article such as a fiberboard. A first fire retardant composition including a hydrated mineral is in the interior of the article. A second fire retardant composition including a boron-containing compound is in the surface of the article. In another embodiment, a fire resistant fibrous composite article includes fibers, a fire retardant hydrated mineral and a zeolite bound together into a consolidated fibrous article which is resistant to water absorption. Another embodiment provides a lignocellulosic fibrous composite board for use in a roof system in which the board is exposed to bonding energy when it is bonded to another roof system component during construction of the roof. Another embodiment relates to a roof system of which a lignocellulosic fibrous composite board is part. The board or the roof system is in compliance with one or more fire resistance or flame and smoke standards. A further embodiment relates to a method of installing a fibrous composite board in a roof system.

### CROSS-REFERENCE TO RELATED APPLICATION

This application claims the benefit of U.S. Provisional Application No. 60/923,236, filed Apr. 13, 2007, and U.S. Provisional Application No. 61/067,160, filed Feb. 26, 2008, the disclosures of which are incorporated herein by reference.

### TECHNICAL FIELD

This invention relates in general to composite materials and in particular to fibrous composite articles such as fiberboards.

### BACKGROUND OF THE INVENTION

Fibrous composite articles are used in many different applications. Some nonlimiting examples of composite articles are fiberboards, oriented strand boards and wood-plastic composites. The composite articles are produced from fibers bound together into a consolidated article, sometimes with the inclusion of a binder.

The composite articles are often used in applications where fire resistance is a desirable property, including without limitation in construction applications. In a particular nonlimiting example, fiberboards are used in a roof system and are exposed to bonding energy when they are bonded to another roof system component during construction of the roof system. The bonding energy may cause damage to the fiberboard.

Consequently, it is known to add fire retardants to fibrous composite articles or to coatings on the articles. For example, U.S. Pat. No. 4,130,458 describes adding to a hardboard the following chemicals evenly distributed throughout: aluminum trihydrate and a source of B₂O₃ selected from the group consisting of boric acid, a mixture of boric acid and borax, and an ammonium borate.

It would be desirable to provide new fire resistant fibrous composite articles.

### SUMMARY OF THE INVENTION

The invention relates to a fire resistant fibrous composite article. The composite article comprises fibers bound together into a consolidated fibrous article such as a fiberboard. A first fire retardant composition comprising a hydrated mineral is included in the interior of the article. A second fire retardant composition comprising a boron-containing compound is included in the surface of the article. When the hydrated mineral is aluminum trihydrate and the boron-containing compound is a source of B₂O₃ selected from the group consisting of boric acid, a mixture of boric acid and borax, and an ammonium borate, at least one of the aluminum trihydrate and the source of B₂O₃ is not evenly distributed throughout the composite article.

In another embodiment, the invention relates to a fire resistant fibrous composite article comprising fibers, a fire retardant hydrated mineral and a zeolite bound together into a consolidated fibrous article. The article is resistant to water absorption in compliance with ASTM C208 for 2-hour water absorption.

In another embodiment, the invention relates to a fibrous composite board for use in a roof system in which the composite board is exposed to bonding energy when the composite board is bonded to another roof system component during construction of the roof system. The composite board comprises lignocellulosic fibers bound together into a consolidated board. The board or the roof system is in compliance with one or more of the following standards: UL 790 Class A and ASTM E 108 Class A for fire resistance, and UL 723 and ASTM E 84 for flame spread and smoke developed.

In a further embodiment, the invention relates to a method of installing a fibrous composite board in a roof system. The method comprises exposing the composite board to bonding energy when bonding the composite board to another roof system component during construction of the roof system. The composite board comprises lignocellulosic fibers bound together into a consolidated board. The board or the roof system is in compliance with one or more of the following standards: UL 790 Class A and ASTM E 108 Class A for fire resistance, and UL 723 and ASTM E 84 for flame spread and smoke developed.

Various aspects of this invention will become apparent to those skilled in the art from the following detailed description of the preferred embodiments along with the drawings.

### BRIEF DESCRIPTION OF THE DRAWINGS

FIG. 1 is an enlarged cross-sectional view of a fiberboard according to the invention.

FIG. 2 is a graph showing water absorption of different fiberboards.

FIG. 3 is a schematic view of one example of a torch-down method of installing a roof membrane on a fiberboard according to the invention.

### DETAILED DESCRIPTION OF THE PREFERRED EMBODIMENTS

This invention relates to any type of fibrous composite article that could benefit from fire resistance. The composite article includes fibers bound together into a consolidated fibrous article. The term “fiber” as used herein includes any fibrous and/or particulate material. Any type of fiber, or a combination of different fibers, suitable for producing composite articles can be used. Some nonlimiting examples of fibers that may be suitable include lignocellulosic fibers, polymer fibers, carbon fibers, or any type of inorganic fibers such as mineral fibers or metal oxide fibers. Some nonlimiting examples of lignocellulosic fibers are those produced from wood, sugar cane residue (bagasse), hemp stalks, straw, cornstalks and sunflower stalks. Some nonlimiting examples of mineral fibers include fibers of a heat-softenable mineral material, such as glass, wollastonite, ceramic, rock, slag, or basalt. Mineral wool consists of fibers made from minerals or metal oxides. The fibers can have any suitable particle sizes.

In a particular embodiment the fibers used in the composite article are substantially all lignocellulosic fibers. In another embodiment, the composite article includes a mixture of lignocellulosic fibers and inorganic fibers. Some nonlimiting examples of such composite articles include lignocellulosic fibers in an amount within a range of from about 50 wt % to about 90 wt % (by dry weight of the consolidated fibrous article), more particularly from about 60 wt % to about 80 wt %, and inorganic fibers in an amount within a range of from about 10 wt % to about 50 wt %, more particularly from about 20 wt % to about 40 wt %. In a particular embodiment the inorganic fibers comprise mineral wool.

The table below summarizes the flame resistance results when mineral wool or glass fiber were used as a partial replacement for wood fibers in fiberboards, or used in a coating on the fiberboards, and the fiberboards were exposed to a flame from a torch in the construction of a roofing system. The roofing system was comprised of a ½ inch (1.27 cm) fire resistant fiberboard test sample placed over a 1 inch (2.54 cm) polyisocyanurate insulation board which was placed over a ¾ inch (1.91 cm) plywood deck. The roof system was tested using a propane torch capable of producing a heat flux of 43,000 BTU/hr. The flame was applied continuously and perpendicular to the fiberboard test sample surface for the duration of the test. The time required for the flame to be observed on the backside of the roof system was recorded.

| | Time of |
|---|---|
| | Flame under |
| | deck (minutes) |
| Sample A - Fiberboard made with wood fibers and ATH | 41 |
| and with standard ATH/Polybor coating | |
| Sample B - Sample A with 5% wood fiber replaced with | 51 |
| mineral wool | |
| Sample C - Sample A with 10% wood fiber replaced with | 55 |
| mineral wool | |
| Sample D - Sample A with 20% wood fiber replaced | 85 |
| with mineral wool | |
| Sample E - Sample A with 30% wood fiber replaced with | 97 |
| mineral wool | |
| Sample F - Sample A with w/ 5% mineral wool in | 49 |
| ATH/Polybor coating | |
| Sample G - Sample A with w/ 10% mineral wool in | 65 |
| ATH/Polybor coating | |
| Sample H - Sample A with w/ 5% glass fiber in | 42 |
| ATH/Polybor coating | |
| Sample I - Sample A with w/ 10% glass fiber in | stopped at 90 |
| ATH/Polybor coating | |

The fibers can be included in any suitable amount in the composite article. In some embodiments, the fibers are included in an amount within a range of from about 40% to about 85% by dry weight of the consolidated fibrous article, particularly from about 45% to about 75%, and more particularly from about 55% to about 70%.

The fibers of the composite article may be bound together without the use of a binder. As a nonlimiting example, lignocellulosic fibers may naturally develop hydrogen bonding when they are formed into a composite article under pressure and high temperature. Alternatively, the composite article may further include a binder. Any type of binder, or any combination of different binders, suitable for making a composite article can be used. Some nonlimiting examples of binders are starch binders such as corn starch, wheat starch and potato starch; and synthetic resins such as urea formaldehyde, melamine formaldehyde, phenol formaldehyde, methylene diphenyl diisocyanate, and polyurethane resin.

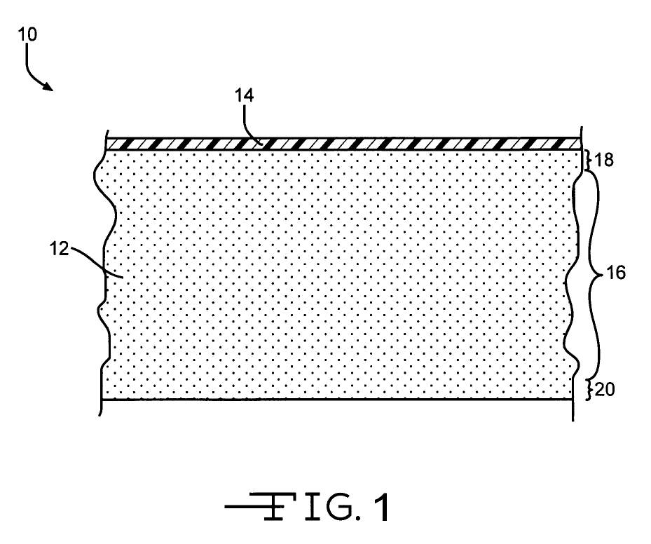

In one embodiment, the composite article also includes a first fire retardant composition in the interior of the article. FIG. 1 shows an example of a composite article 10 including a fiberboard 12 in the interior of the article and a coating 14 which forms a surface of the article. Alternatively, if the article 10 did not include the coating 14, the surface of the article could be one or both of the surface portions 18 and 20 of the fiberboard and the interior of the article could be the remaining portion of the fiberboard (such as interior portion 16). Either the coating 14 or the surface portion 18 can have any suitable thickness, for example without limitation, within a range of from about 0.05 millimeters to about 5 mm.

The first fire retardant composition includes a hydrated mineral having fire retardant properties. Any suitable type of hydrated mineral, or combinations of different hydrated minerals, can be used. Some nonlimiting examples of hydrated minerals that may be suitable include aluminum trihydrate, magnesium hydroxide, magnesium bromate hexahydrate, magnesium sulfate heptahydrate, magnesium iodate tetrahydrate, magnesium antimonate hydrate, magnesium chlorplatinate hexahydrate, calcium ditartrate tetrahydrate, calcium chromate dihydrate, sodium thiosulfate pentahydrate, sodium pyrophosphate hydrate, potassium ruthenate hydrate, potassium sodium tartrate tetrahydrate, zinc iodate dihydrate, zinc sulfate heptahydrate, zinc phenol sulfonate octahydrate, manganese chloride tetrahydrate, cobalt orthophosphate octahydrate, beryllium oxalate trihydrate, zirconium chloride octahydrate, thorium hypo phosphate hydrate, thallium sulfate heptahydrate, and dysprosium sulfate octahydrate. Any such hydrated mineral may be suitable in one or more various forms, including without limitation different extents of hydration or different crystalline forms. In a particular embodiment, the hydrated mineral is aluminum trihydrate (“ATH”, also known as “alumina trihydrate”). Optionally, the first fire retardant composition can include one or more other fire retardants in addition to the hydrated mineral. Such fire retardants may include, but are not limited to, antimony oxide, diammonium phosphate, oxalates, brominated lignin sulphonates, ammonium sulfamate and antimony chlorite.

The composite article also includes a second fire retardant composition in the surface of the article. The second fire retardant composition includes a boron-containing compound. Especially suitable are boron-rich compounds, by which is meant compounds having a content of combined boron equivalent to more than 25% by weight B₂O₃. Some suitable compounds may have more than 35% by weight B₂O₃. Some nonlimiting examples of such compounds are boric oxide itself, boric acid, disodium octaborate tetrahydrate, borax (sodium tetraborate decahydrate), borax pentahydrate, anhydrous borax, and various potassium and ammonium borates. Many boron-rich compounds are commercially available from U.S. Borax Inc., Valencia, Calif., including without limitation Polybor® (disodium octaborate tetrahydrate), Optibor® (boric acid), Neoborg (borax pentahydrate), and Dehybor® (anhydrous borax). In one embodiment, the boron-containing compound is a mixture of boric acid and borax. Optionally, the second fire retardant composition can include one or more other fire retardants in addition to the boron-containing compound. In a particular embodiment, the second fire retardant composition also includes a hydrated mineral which can be the same or different from that used in the first composition. In another particular embodiment, the formulation of the second fire retardant composition is different from the formulation of the first fire retardant composition. However, alternatively the formulations could be the same in some embodiments.

In a particular embodiment, when the hydrated mineral is aluminum trihydrate and the boron-containing compound is a source of B₂O₃ selected from the group consisting of boric acid, a mixture of boric acid and borax, and an ammonium borate, at least one of the aluminum trihydrate and the source of B₂O₃ is not evenly distributed throughout the composite article. In another particular embodiment, any boron-containing compound that is a source of B₂O₃ selected from the group consisting of boric acid, a mixture of boric acid and borax, and an ammonium borate, is not evenly distributed throughout the composite article. In another particular embodiment, any boron-containing compound that is a source of B₂O₃ is not evenly distributed throughout the composite article.

The first and second fire retardant compositions can be included in any suitable amounts. In one embodiment, the concentration of the second fire retardant composition as a percentage of the surface of the composite article (by way of nonlimiting example, as a percentage of the coating) is different from the concentration of the first fire retardant composition as a percentage of the interior of the composite article (by way of nonlimiting example, as a percentage of the consolidated fibrous article such as a fiberboard). In a particular embodiment, the second concentration as a percentage of the surface is higher than the first concentration as a percentage of the interior, by way of nonlimiting example it may be at least about two times the first concentration. In a particular embodiment, the second fire retardant composition is included in an amount up to about 100% by dry weight of the surface and the first fire retardant composition is included in an amount within a range of from about 5% to about 60% by dry weight of the consolidated fibrous article. In another particular embodiment, the boron-containing compound is not included in the interior of the article, although in other embodiments it can be included.

In addition to the above-described materials, the composite article may optionally include other materials suitable for making such articles. By way of nonlimiting example, the composite article may include a water repelling agent to improve the moisture resistance of the article. Any type of water repelling agent, or any combination of different water repelling agents, suitable for making composite articles can be used. Some nonlimiting examples of water repelling agents include waxes, oils, and hydrophobic chemicals such as alkylalkoxysilanes. By way of nonlimiting example, any suitable synthetic or natural wax or combinations thereof can be used.

The composite article may also include one or more fillers. Any type of filler, or any combination of different fillers, suitable for making composite articles can be used. Some nonlimiting examples of fillers that may be suitable are various clays (including but not limited to bentonite and kaolin), both expanded and unexpanded versions of pearlite and/or vermiculite, calcium carbonate, zeolite, silica, talc, mica, gypsum and fly ash.

Any other additives suitable for use in composite articles can optionally be included. Some nonlimiting examples of additives include retention aids, dry strength additives, biological control agents and processing aids. Any suitable retention aid or mixtures of different retention aids can be used, which can include by way of nonlimiting example many different types of cationic, anionic, nonionic or zwitterionic materials. Any suitable processing aids or mixtures of different processing aids can be used, which can include without limitation aluminum sulfate or sodium aluminate.

In a particular nonlimiting example, the composite article includes wood fibers, starch, the first fire retardant, wax and aluminum sulfate. In one embodiment the composite article also includes at least one of the following materials: zeolite, clay, pearlite, vermiculite, glass fibers and/or mineral wool.

In addition to the second fire retardant composition, the coating of the composite article may optionally include other materials suitable for making such coatings. As a nonlimiting example, the coating may include any suitable clay, such as bentonite clay. It may also include one or more rheology modifiers and/or dyes. In a particular nonlimiting example, the coating includes one or more of the following materials: zeolite, clay, pearlite, vermiculite, mineral wool and/or glass fibers.

In one embodiment, the composite article has a minimum transverse strength in either direction of at least about 7 lb_{f} (31.1 N) (ASTM C208, Transverse Strength) (the test is described in ASTM C209).

Note that when reference is made herein to standards or tests such as those published by ASTM or UL, the reference is meant to include any equivalents such as foreign counterparts or equivalent versions that are developed in the future.

In another embodiment, the consolidated fibrous article includes a combination of a hydrated mineral and a zeolite. This combination can be included in any suitable amount, by way of nonlimiting example, an amount within a range of from about 15% to about 60% by dry weight of the article, particularly from about 20% to about 40%, and more particularly from about 25% to about 35%. In some embodiments, the weight ratio of the hydrated mineral to the zeolite is within a range of from about 0.5:1 to about 100:1, particularly from about 1:1 to about 6:1, and more particularly from about 1.5:1 to about 2:1.

Any suitable zeolite can be included in the article. Zeolites are aluminosilicate minerals having a crystalline structure that is porous but remains rigid in the presence of water. Some nonlimiting examples of zeolites are analcime, chabazite, clinoptilolite, heulandite, natrolite, phillipsite and stilbite.

In some embodiments, the composite article further comprises a water repelling agent present in a suitable range. As a nonlimiting example, such a water repelling agent may be present within a range of from about 0.1% to about 10% by dry weight of the consolidated fibrous article, particularly from about 0.25% to about 4%, and more particularly from about 0.5% to about 3%. Any suitable water repelling agent can be used.

The composite article may further include any other suitable materials, such as any of those described above or others. Optionally, the composite article may include a coating such as described above or having a different composition. In a particular nonlimiting example, the composite article is a fiberboard containing 63.4% wood fibers, 1% starch binder, 18% ATH, 15% zeolite, 2% wax, 0.5% aluminum sulfate, and 0.1% retention aid (all by dry weight of the composite article), and the fiberboard may be coated with a coating containing 52% water, 3% clay, 22% ATH, 22% Polybor, and 1% dye (all by dry weight of the coating).

In one embodiment, the composite article is resistant to water absorption in compliance with ASTM C208 for 2-hour water absorption and the associated test described in ASTM C209. The amount of water absorbed is calculated from the increase in weight of the specimen during the submersion, and the water absorption is expressed as the volume percent increase of the specimen after conditioning.

In a particular embodiment, the composite article meets all the ASTM C208 requirements except for thermal conductivity. However, in other embodiments the composite article may meet fewer of these requirements.

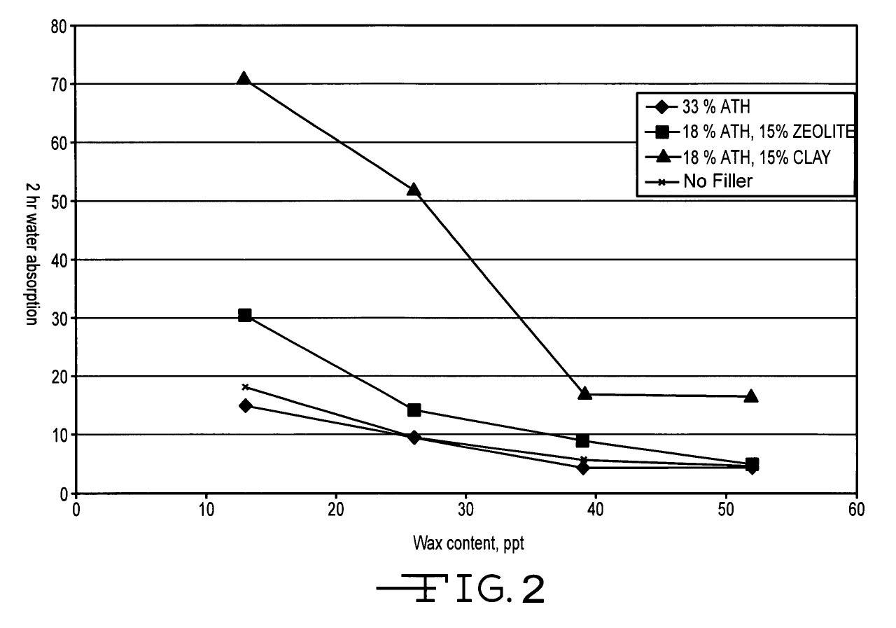

FIG. 2 is a graph showing the results of 2-hour water absorption tests performed on fiberboards having different compositions. The x-axis shows the wax content of the fiberboards (the more wax the less water absorbed). Fiberboards containing 33% ATH (hydrated mineral) had the lowest water absorption (the bottom curve on the graph). Fiberboards containing no filler or hydrated mineral, and thus a higher percentage of wood fibers, had the next lowest water absorption. When a portion of the hydrated mineral was replaced with a clay filler (18% ATH, 15% clay), the water absorption of the fiberboards increased significantly (the top curve on the graph). However, when the same portion of the hydrated mineral was replaced with a zeolite (18% ATH, 15% zeolite), the fiberboards still had a low water absorption which was almost as good as that of the 33% ATH fiberboards. (The percentages are all by dry weight of the fiberboard.)

The components of the consolidated fibrous article can be arranged in any suitable configurations. By way of nonlimiting example, the fibrous article can include layered structures. In one embodiment, a fiberboard is produced having separate layers of different fibers, a nonlimiting example of which is a layer of wood fibers and a layer of inorganic fibers and/or a layer of zeolite. Alternatively, a fiberboard could be produced having a layer of wood fibers and a layer of hydrated mineral. This layered structure refers to the structure of the fiberboard itself and not to a coating or facer on the board (although such layers can also be added). Although in some embodiments the separate layers of the fiberboard have different compositions, in other embodiments they could have the same compositions. The multiple layers of the fiberboard are all together considered the “interior” of the composite article.

Similarly, the surface of the composite article, including by way of nonlimiting example a coating on a fiberboard, can have any suitable configurations, such as multiple layers. The layers can be the same or different in composition. The multiple layers are all together considered the “surface” of the composite article.

The structures and methods of manufacturing composite articles are well-known in the building materials field, so they will be described only briefly below.

Hardboards are panels manufactured primarily from interfelted lignocellulosic fibers which are consolidated under heat and pressure in a hot press. They typically have a density above 500 kg/m³, and more typically in the range of 800-1100 kg/m³. Other materials may be added to improve certain properties such as stiffness, hardness, finishing properties, resistance to abrasion and moisture as well as to increase strength, durability and utility. Hardboards may be produced by many processes, including the well-known wet process or dry process.

Insulating fiberboards, also known as softboards and low density fiberboards, are fibrous felted homogenous panels made from lignocellulosic fibers. They typically have a density in the range of 160-500 kg/m³. These boards are characterized by an integral bond which is produced by interfelting of the fibers, but which are uncompressed or lightly compressed. Other materials may be added during manufacture to improve certain properties.

Particle boards are made from fibers such as wood chips, sawmill shavings or sawdust, and other materials. The components are mixed together and formed into a sheet, which is then compressed under pressure and high temperature. The particle boards typically have a density from 590-800 kg/m³.

Oriented strand boards are made from fibrous strands and other materials. The strands are layered in specific orientations and the components are formed into a sheet, which is then compressed under pressure and high temperature.

Wood-plastic composites are made from thermoplastic polymers, fibers such as wood dust (wood flour) or wood fibers, and other materials. The fibers and other materials are combined with molten thermoplastic polymer to produce a homogeneous mixture, which is then formed into the shape of the composite article by extrusion or molding.

The manufacture of the fibrous composite article can be done using any suitable manufacturing equipment and process, which can include continuous production and/or batch production. As a nonlimiting example, any suitable paper machine such as a Fourdrinier or a cylinder former (e.g., an Oliver drum machine) can be used in the production of a fiberboard. In a particular nonlimiting example, in a wet process, an insulating fiberboard is manufactured by filtering a dilute slurry of dispersed wood or plant fibers over a moving forming fabric. The filtered mat is then pressed to remove additional water and produce a consolidated board. Vacuum may also be used for the water removal. The forming process of the fiberboard may be similar to the wet-end section of a traditional paper machine. Remaining water may be removed from the fiberboard in a tunnel dryer. The fibrous composite article could alternatively be manufactured using a dry process.

To impart fire resistance, aluminum trihydrate is added to the slurry prior to forming. By way of nonlimiting example, the fiberboard may be comprised of 15% to 60% of aluminum tri-hydrate based on dry weight prior to coating. Other ingredients may be added to the slurry including, but not limited to, one or more binders, retention aids, other fire retardants, dry strength additives, water repelling agents, biological control agents and other processing aids. By way of nonlimiting example, the slurry may include one or more of the following: starch, aluminum sulfate, sodium aluminate, retention aid, water repelling agent and/or defoamer.

A coating slurry containing borates, including by way of nonlimiting example boric acid, borax, or Polybor™, and aluminum trihydrate is applied to a major surface of the fiberboard. The coating can be applied to the fiberboard before or after the board is dried. The coating may also be applied to both major surfaces or all surfaces of the fiberboard. By way of nonlimiting example, the coating slurry may be applied at a rate of 0.1% to 15% by dry weight of composite board or article for each the aluminum trihydrate and the borate. Other additives may be added to the coating formulation including, but not limited to, rheology modifiers and dyes. The coating slurry may be applied to one or more surfaces. The coating can be applied by any suitable method, including without limitation by means of flood coating, curtain coating, spraying, rolling, brushing, dipping or other well-known methods.

The composite article can be used in a wide variety of different applications. In some embodiments, the composite article is used as part of a roofing system, as exterior sheathing, or as part of an interior application, in residential, commercial, industrial or institutional construction. By way of nonlimiting example, the composite article may be used in a roofing system as cover board, recover board, insulation board, cant strip, or tapered edge segment. The composite article may be used as structural or non-structural exterior sheathing. The composite article may be used in an interior application including without limitation a floor, wall or ceiling or any application within the interior of a building, including without limitation part of a sound control panel, a core material for a door, a partition, furniture, a tack board, a dry erase board or other display material, or a ceiling panel.

In a particular application, the composite article is used in the construction of a roof system, in which the composite article is exposed to bonding energy when it is bonded to another roof system component during construction of the roof system. The other roof system component can be any type suitable for constructing a roof system and suitable for bonding to the composite article. Some nonlimiting examples of other roof system components include roof membranes, such as those made with a bituminous and/or polymeric material, and insulation boards, such as those made with a rigid polymer foam.

Any suitable type of bonding energy can be used to bond the composite article to the other roof system component during construction of the roof system. In a particular nonlimiting example, a torch or other heat source is used to apply heat that causes melting of the surface of the other component which enables the component to adhere to the composite article. By way of nonlimiting example, a roofing membrane or insulation board can be heated to melt the surface for bonding to the composite article during construction of a roof. However, many other types of bonding energy could also be used. By way of nonlimiting example, a chemical may be applied between the composite article and the other component that creates a reaction that bonds them together. In a particular nonlimiting example, a coating on a rubber capsheet can create a reaction with the wood of the composite article that bonds the two together. In another nonlimiting example, different materials can be coated on the composite article and the other component that are activated when combined thereby producing a reaction that bonds them together. In another nonlimiting example, a material is coated on the composite article and/or the other component that is activated and creates a bond when it is exposed to a certain frequency of light (or laser) or another type of radiation such as ultrasound, etc. In a further nonlimiting example, an infrared heat gun or microwaves could be used to produce a bonding energy. Other possible sources of bonding energy may include, without limitation, chemical agents and processes, biological agents and processes, and uses of light, sound, radiation, gravity and motion. In addition, the application of the bonding energy may vary; as a particular nonlimiting example, a heat source may be applied primarily to the composite article rather than to the other roof system component (such as a membrane). However, either the composite article or the other roof system component (or both) may be exposed to the bonding energy during construction of the roof system.

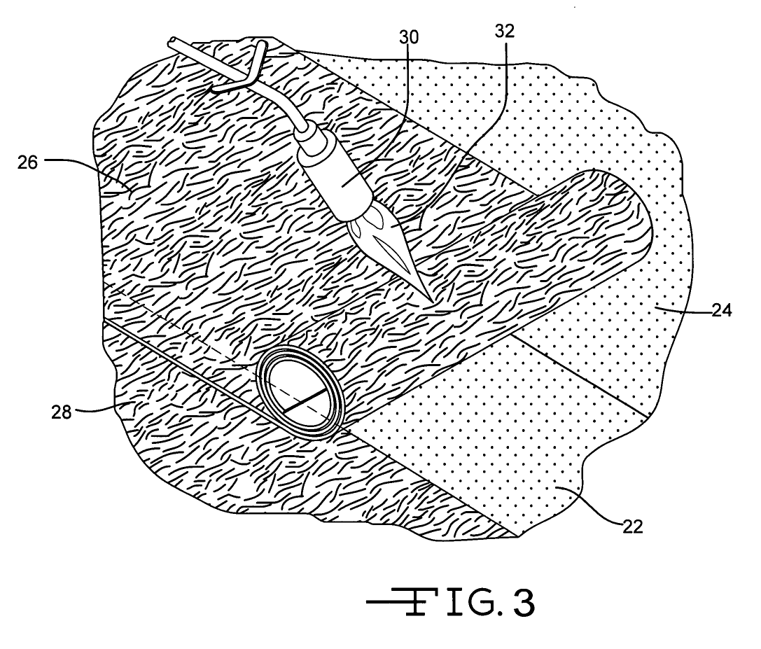

The composite article for the roof system application can be any suitable type of article. In one nonlimiting example, the composite article is in the form of a composite board such as a fiberboard. FIG. 3 shows a nonlimiting example in which courses of the composite boards 22 and 24 are fastened to a roof deck (below the boards) to form a roofing substrate. The roof system can be used with any type of roof deck, but in some embodiments the roof deck is substantially flat or low-pitched. The deck may be newly constructed, a deck exposed by the removal of old roofing, or existing roofing in suitable condition for recovering. The roofing substrate provides insulation, a fire retardant barrier, and a smooth surface for applying the roof membrane.

The composite boards 22 and 24 can have any dimensions suitable for use in the roof system. By way of nonlimiting example, in the USA the boards may be either 4×4 feet (1.22×1.22 meters) or 4×8 feet (1.22×2.44 meters), and they may have a thickness of ⅜ inch (0.95 cm), ½ inch (1.27 cm) or ¾ inch (1.91 cm). Sometimes the boards may be laminated together, as a nonlimiting example by laminating ½ inch (1.27 cm) thick plies together to produce a board that is 1 inch (2.54 cm) thick. In some embodiments the boards add insulation to the roof system; as a nonlimiting example, they may have an R-value within a range of from about 0.75 to about 1.5 for a ½ inch (1.27 cm) board.

Some roof systems may include one or more layers of rigid insulation (not shown) or other material(s) between the roof deck and the composite boards. By way of nonlimiting example, insulation boards made from a rigid polymer foam may be used.

As shown in FIG. 3, a roof membrane 26 is applied on the upper surface of the composite boards 22 and 24. The roof membrane 26 overlaps an adjacent roof membrane 28. Any suitable type of roof membrane can be used. As a nonlimiting example, the roof membrane may comprise a reinforcement mat such as a nonwoven fiberglass mat which is coated on both sides with a bituminous and/or polymeric material.

The roof membrane 26 is adhered to the composite boards 22 and 24 and the adjacent membrane 28 during its application by applying heat from a torch 30 to the bottom surface of the membrane 26. The heat melts the bituminous material on the bottom of the membrane causing it to adhere to the composite boards and the adjacent membrane when it contacts them. This is known as a “torch-down” roof membrane installation process. Alternatively, the heat could be applied from any other direction to cause melting of the membrane.

In some roof systems the roof membrane 26 has roofing granules (not shown) embedded on its upper surface. In other roof systems the roof membrane 26 is the base sheet of a two-ply roof membrane system that includes a cap sheet (not shown) on top of the base sheet. The cap sheet may be similar in construction to the base sheet and it may optionally have roofing granules on its upper surface.

As shown in FIG. 3, the flame 32 from the torch 30 comes close to or may (as mentioned above) directly contact the composite boards 22 and 24 during application of the roof membrane 26. Advantageously, the composite boards of the invention are resistant to fire and other bonding energy so that they resist damage during construction of the roof system. In one embodiment, the composite article can be any type of composite board for use in a roof system in which the board is exposed to bonding energy when it is bonded to another roof system component, wherein the composite board or the roof system is in compliance with one or more of the following standards: UL 790 Class A and ASTM E 108 Class A for fire resistance when installed on a wood deck, and UL 723 and ASTM E 84 for flame spread and smoke developed. In a particular embodiment, the composite board or roof system is in compliance with all these standards. Also, in a particular embodiment it is expected that the composite board has an FM Class 1 rating in accordance with FM 4450 and FM 4470 (Factory Mutual).

The fibrous composite article can be used in any suitable roof system. In a particular nonlimiting example, the roof system includes a plywood deck ( 15/32 inch thick), a fire resistant fiberboard made with wood fibers and fire retardant applied on top of the deck, a base sheet (80 mm thick) made from polymer modified asphalt applied on top of the fiberboard, and a cap sheet made from a scrim coated with polymer modified asphalt on top of the base sheet.

Underwriters Laboratories Standard UL 790, “Standard Test Methods for Fire Tests of Roof Coverings”, measures the fire resistance performance of roof coverings exposed to simulated fire sources originating from outside a building on which the coverings are installed. Class A roof coverings are effective against severe fire test exposures, providing a high degree of fire protection to the roof deck.

The test methods of ASTM (formerly known as American Society for Testing and Materials) E 108 “Standard Test Methods for Fire Tests of Roof Coverings” include simulated fire exposure to the outside of the roof covering. They measure the surface spread of flame and the ability of the roof covering to resist fire penetration from the exterior to the underside of a roof deck under conditions of exposure. Class A tests are applicable to roof coverings that are effective against severe test exposure and afford a high degree of fire protection to the roof deck.

Underwriters Laboratories Standard UL 723, “Test for Surface Burning Characteristics of Building Materials”, measures time and distance at which a flame propagates horizontally along the surface of a tested sample, and it measures the smoke given off from the sample when exposed to flame. In some embodiments, the composite articles have a flame spread index of not greater than 75, particularly not greater than 50, and more particularly not greater than 25. A similar test is disclosed in ASTM E 84.

In some nonlimiting embodiments, the disclosed articles, boards, methods and/or systems provide an advantageous combination of fire resistance on the one hand, and increased strength and lower product weight when compared with articles, boards, methods and systems comprising fire retardant chemicals evenly distributed throughout. Some nonlimiting embodiments offer the additional advantage of less toxic chemical compositions than many alternative fire retardant chemicals available.

In accordance with the provisions of the patent statutes, the principle and mode of operation of this invention have been described in its preferred embodiments. However, it must be understood that this invention may be practiced otherwise than as specifically described without departing from its spirit or scope.

1. A fire resistant fibrous composite article comprising:
fibers bound together into a consolidated fibrous article;
the composite article including an interior and a surface;
the composite article further comprising a first fire retardant composition including a hydrated mineral in the interior of the article; and
the composite article further comprising a second fire retardant composition including a boron-containing compound in the surface of the article;
provided that when the hydrated mineral is aluminum trihydrate and the boron-containing compound is a source of B₂O₃ selected from the group consisting of boric acid, a mixture of boric acid and borax, and an ammonium borate, at least one of the aluminum trihydrate and the source of B₂O₃ is not evenly distributed throughout the composite article.

2. The composite article of claim 1 wherein any boron-containing compound that is a source of B₂O₃ selected from the group consisting of boric acid, a mixture of boric acid and borax, and an ammonium borate, is not evenly distributed throughout the composite article.

3. The composite article of claim 1 wherein the formulation of the second fire retardant composition is different from the formulation of the first fire retardant composition.

4. The composite article of claim 1 wherein the concentration of the second fire retardant composition as a percentage of the surface is different from the concentration of the first fire retardant composition as a percentage of the interior.

5. The composite article of claim 1 wherein the second fire retardant composition further includes a hydrated mineral.

6. The composite article of claim 1 wherein the concentration of the second fire retardant composition as a percentage of the surface is greater than the concentration of the first fire retardant composition as a percentage of the interior.

7. The composite article of claim 1 wherein the hydrated mineral comprises aluminum trihydrate.

8. The composite article of claim 1 wherein the consolidated fibrous article is composed of multiple layers.

9. The composite article of claim 8 wherein the layers have different compositions.

10. The composite article of claim 1 wherein the surface is composed of multiple layers.

11. The composite article of claim 10 wherein the layers have different compositions.

12. The composite article of claim 1 wherein the surface has a thickness within a range of from about 0.05 millimeters to about 5 mm.

13. The composite article of claim 1 which has a flame spread index of not greater than 75.

14. The composite article of claim 1 wherein the surface of the composite article comprises a coating on the fibrous article and the second fire retardant composition is included in the coating.

15. The composite article of claim 1 wherein the fibers comprise lignocellulosic fibers.

16. The composite article of claim 15 wherein the fibers additionally comprise inorganic fibers.

17. The composite article of claim 16 wherein the inorganic fibers comprise mineral wool.

18. The composite article of claim 1 which is a fiberboard.

19. The composite article of claim 1 which further comprises a water repelling agent.

20. The composite article of claim 1 which is used as part of a roofing system, as exterior sheathing, or as part of an interior application, in residential, commercial, industrial or institutional construction.

21. A fire resistant fibrous composite article comprising:
fibers, a fire retardant hydrated mineral and a zeolite bound together into a consolidated article;
wherein the composite article is resistant to water absorption in compliance with ASTM C208 for 2-hour water absorption.

22. The composite article of claim 21 wherein the fibers are included in an amount within a range of from about 40% to about 85% by weight of the composite article, and the combination of the hydrated mineral and the zeolite is included in an amount within a range of from about 15% to about 60% by weight of the composite article.

23. The composite article of claim 21 wherein the fibers comprise lignocellulosic fibers.

24. The composite article of claim 23 wherein the fibers additionally comprise mineral wool.

25. The composite article of claim 23 wherein the composite article itself or a roof system of which the composite article is a part is in compliance with one or more of the following standards: UL 790 Class A and ASTM E 108 Class A for fire resistance, and UL 723 and ASTM E 84 for flame spread and smoke developed.

26. The composite article of claim 25 wherein the composite article or roof system is in compliance with all of the listed standards.

27. The composite article of claim 21 wherein the composite article has a minimum transverse strength in either direction of at least about 7 lb_{f} (31.1 N).

28. The composite article of claim 21 wherein the weight ratio of the hydrated mineral to the zeolite is within a range of from about 0.5:1 to about 100:1.

29. The composite article of claim 21 wherein the hydrated mineral comprises aluminum trihydrate.

30. The composite article of claim 21 which further comprises a water repelling agent.

31. A fibrous composite board for use in a roof system in which the composite board is exposed to bonding energy when the composite board is bonded to another roof system component during construction of the roof system, the composite board comprising:
lignocellulosic fibers bound together into a consolidated board;
wherein the composite board or the roof system is in compliance with one or more of the following standards: UL 790 Class A and ASTM E 108 Class A for fire resistance, and UL 723 and ASTM E 84 for flame spread and smoke developed.

32. The composite board of claim 31 wherein the board or roof system is in compliance with all of the listed standards.

33. The composite board of claim 31 wherein the board includes an interior and a surface;
the composite board further comprising a first fire retardant composition including a hydrated mineral in the interior of the board; and
the composite board further comprising a second fire retardant composition including a boron-containing compound in the surface of the board;
provided that when the hydrated mineral is aluminum trihydrate and the boron-containing compound is a source of B₂O₃ selected from the group consisting of boric acid, a mixture of boric acid and borax, and an ammonium borate, at least one of the aluminum trihydrate and the source of B₂O₃ is not evenly distributed throughout the composite board.

34. The composite board of claim 33 wherein any boron-containing compound that is a source of B₂O₃ selected from the group consisting of boric acid, a mixture of boric acid and borax, and an ammonium borate, is not evenly distributed throughout the composite board.

35. The composite board of claim 33 wherein the formulation of the second fire retardant composition is different from the formulation of the first fire retardant composition.

36. The composite board of claim 33 wherein the concentration of the second fire retardant composition as a percentage of the surface is different from the concentration of the first fire retardant composition as a percentage of the interior.

37. The composite board of claim 36 wherein the concentration of the second fire retardant composition as a percentage of the surface is greater than the concentration of the first fire retardant composition as a percentage of the interior.

38. The composite board of claim 31 which further comprises a fire retardant hydrated mineral and a zeolite, and wherein the composite board is resistant to water absorption in compliance with ASTM C208 for 2-hour water absorption.

39. The composite board of claim 31 wherein substantially all the fibers in the board are lignocellulosic fibers

40. The composite board of claim 31 additionally comprising mineral wool.

41. The composite board of claim 31 wherein the bonding energy comprises heat.

42. A method of installing a fibrous composite board in a roof system comprising:
exposing the composite board to bonding energy when bonding the composite board to another roof system component during construction of the roof system;
wherein the composite board or the roof system is in compliance with at least one of the following standards: UL 790 Class A and ASTM E 108 Class A for fire resistance, and UL 723 and ASTM E 84 for flame spread and smoke developed.

43. The method of claim 42 wherein the composite board or roof system is in compliance with all of the listed standards.

44. The method of claim 42 wherein the composite board includes an interior and a surface;
the composite board further comprising a first fire retardant composition including a hydrated mineral in the interior of the board; and
the composite board further comprising a second fire retardant composition including a boron-containing compound in the surface of the board;
provided that when the hydrated mineral is aluminum trihydrate and the boron-containing compound is a source of B₂O₃ selected from the group consisting of boric acid, a mixture of boric acid and borax, and an ammonium borate, at least one of the aluminum trihydrate and the source of B₂O₃ is not evenly distributed throughout the composite board.

45. The method of claim 44 wherein any boron-containing compound that is a source of B₂O₃ selected from the group consisting of boric acid, a mixture of boric acid and borax, and an ammonium borate, is not evenly distributed throughout the composite board.

46. The method of claim 44 wherein the formulation of the second fire retardant composition is different from the formulation of the first fire retardant composition.

47. The method of claim 44 wherein the concentration of the second fire retardant composition as a percentage of the surface is different from the concentration of the first fire retardant composition as a percentage of the interior.

48. The method of claim 47 wherein the concentration of the second fire retardant composition as a percentage of the surface is greater than the concentration of the first fire retardant composition as a percentage of the interior.

49. The method of claim 42 wherein the composite board further comprises a fire retardant hydrated mineral and a zeolite, and wherein the composite board is resistant to water absorption in compliance with ASTM C208 for 2-hour water absorption.

50. The method of claim 42 wherein the bonding energy comprises heat.

51. A roof system comprising:
a wood deck;
a fiberboard made from lignocellulosic fibers applied on top of the deck;
a base sheet applied on top of the fiberboard; and
optionally a cap sheet applied on top of the base sheet;
wherein the roof system of which the composite board is a part is in compliance with UL 790 Class A and ASTM E 108 Class A for fire resistance.
